(19) United States
(12) Patent Application Publication
(10) Pub. No.: US 2005/0223407 A1
(43) Pub. Date: Oct. 6, 2005

(54) Wireless local area audio/visual information distribution system and method by impulse radio

(76) Inventors: Larry W. Fullerton, Brownsboro, AL (US); Ivan A. Cowie, Madison, AL (US); Timothy T. Payment, Huntsville, AL (US); James L. Richards, Fayetteville, TN (US)

Correspondence Address: SPRINKLE IP LAW GROUP, 1301 W. 25TH STREET, SUITE 408, AUSTIN, TX, 78705, US

(21) Appl. No.: 11/140,797

(22) Filed: May 31, 2005

Related U.S. Application Data
(63) Continuation of application No. 09/407,115, filed on Sep. 27, 1999.

(51) Int. Cl. H04N 7/18; H04N 11/00; H04N 7/00; H04N 5/44; H04N 5/50; H04N 7/16

(52) U.S. Cl. 725/81; 348/734; 348/731; 725/80; 725/136

(57) ABSTRACT

Impulse radio links are applied as the wireless means for allowing the separation of traditionally wired audio/video displays from their sources of information. This wireless separation affords an enhanced information system architecture in which a remote user interface can select from a variety of information and/or entertainment sources. The data bandwidth and superior performance of impulse radios in a high RF multipath environment open these previously hardwired interfaces to a wireless implementation. For example, untethered television is provided.

### BACKGROUND OF THE INVENTION

1. Field of the Invention

The invention generally relates to the use of Impulse Radios in providing a wireless means of locally distributing audio and/or video information, typically within a home or comparable area.

2. Related Art

Typical television displays (and other video entertainment and computer displays) are directly tied (i.e. hardwired) to their source of information. The TV tube/display is packaged with the RF tuner, which is wired to the antenna, cable, VCR, or satellite dish system. Computer monitors are wired to the video boards, which are plugged into the computer chassis, which is often further wired by modem to a telephone line or other network link. Video and computer game displays are similarly constrained by the host TV or computer that serves them. Breaking these direct display connections and operating without wires effectively untethers the display from its information source, thereby increasing the user's flexibility in display placement and the overall convenience of use.

For example, a typical commercial TV cable carries nearly 100 channels that are simultaneously available to each connected TV tuner. In choosing a channel, the user essentially routes one of those channels to the display tube, which is directly connected to the tuner. TV remote controls are well known to have untethered the channel selection part of the process, but the display itself remains tied to the tuner and the antenna or cable. What is needed is a means for untethering the display to go along with the currently untethered remote control, and to extend the range of this untethered TV to cover the entire home without being restricted by walls.

While one might initially compare such an “Untethered TV” to a “portable TV” which is a well-established product, a closer examination reveals some key architectural differences. The portable TV retains its channel tuner and its antenna link to the local TV broadcast signals. As a result the quality of the display depends on the placement and adjustment of the portable TV and its “rabbit ears” antenna. Increasingly, the source of information desired for display is other than a locally broadcast signal, e.g. cable, VCR, satellite, or computer generated. With an Untethered TV (UTV), the information source remains fixed, only the display and user controls are made portable. As a result the TV tuner remains in a fixed location where it can be tied to an external antenna for optimal reception of local broadcasts. Further, all sources of information that might be desired for display may remain in a single location in the home. UTV adds a communication link back from the remote portion to the fixed portion to allow the user to command channel selection. This added link further distinguished UTV from a conventional portable TV. One or more UTVs allow users to remotely access/control the information sources and select one (or more) for display.

The key to such a UTV is the ability to provide a high enough bandwidth or data rate from the information source to the untethered display to support a high quality video/audio interface, and to maintain the display quality despite varying conditions such as sources of electrical interference and the number of intervening walls that separate the UTV from the information sources. A lower data rate signal from the UTV back to the information source supports the user control commands. From the user's perspective, the net effect is the movement of the TV display and speakers from the conventional television set, and repackaging them with the remote control functions that now work through walls.

### SUMMARY OF THE INVENTION

The present invention applies impulse radio links as the wireless means for allowing the separation of traditionally wired audio/video displays from their sources of information. This wireless separation affords an enhanced information system architecture in which a remote user interface can select from a variety of information and/or entertainment sources. The data bandwidth and superior performance of impulse radios in a high RF multipath environment open these previously hardwired interfaces to a wireless implementation. One embodiment of the present invention can also be referred to as “untethered television” or “untethered TV”.

Impulse radio was first fully described in a series of patents, including U.S. Pat. Nos. 4,641,317 (issued Feb. 3, 1987), 4,813,057 (issued Mar. 14, 1989), 4,979,186 (issued Dec. 18, 1990) and 5,363,108 (issued Nov. 8, 1994) to Larry W. Fullerton. A second generation of impulse radio patents include U.S. Pat. Nos. 5,677,927 (issued Oct. 14, 1997), 5,687,169 (issued Nov. 11, 1997) and 5,832,035 (issued Nov. 3, 1998) to Fullerton et al. These patent documents are incorporated herein by reference.

Co-pending application Ser. No. 09/332,501 (filed Jun. 14, 1999), System and Method for Impulse Radio Power Control, is also incorporated herein by reference.

Further embodiments, features, and advantages of the present inventions, as well as the structure and operation of the various embodiments of the present invention, are described in detail below with reference to the accompanying drawings.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a Block Diagram of a Conventional Television System.

FIG. 2 shows the Block Diagram of FIG. 1 with the addition of a Remote Controller.

FIG. 3 is a Block Diagram of an Untethered TV in which the Audio and Video Subsystems are linked to the TV Tuner by Impulse Radios.

FIG. 4 shows the Block Diagram of FIG. 3 with the addition of a Remote Controller for the UTV Remote Unit.

FIG. 5 shows a Generalized Version of the Untethered TV.

FIG. 6 depicts the use of Multiple UTV Remote Units with a Single Base Unit.

FIGS. 7A to 7F relate to a multipath feature and algorithms.

### DETAILED DESCRIPTION OF THE PREFERRED EMBODIMENTS

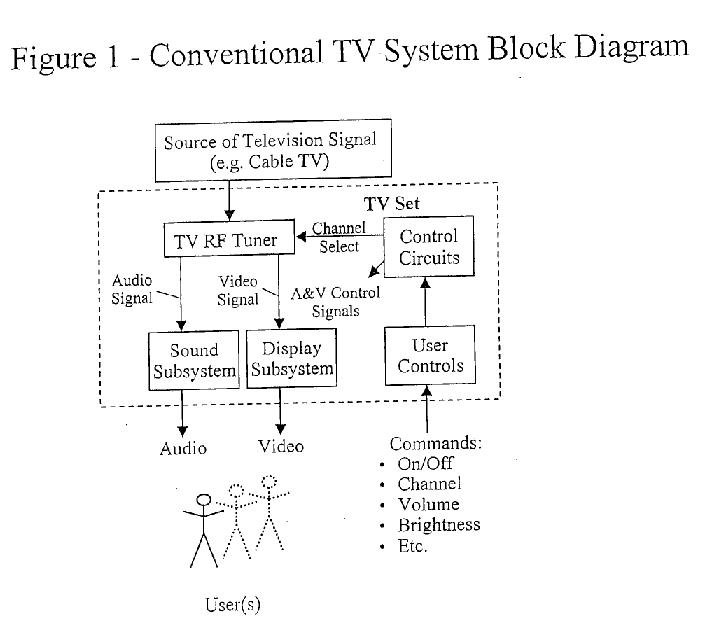

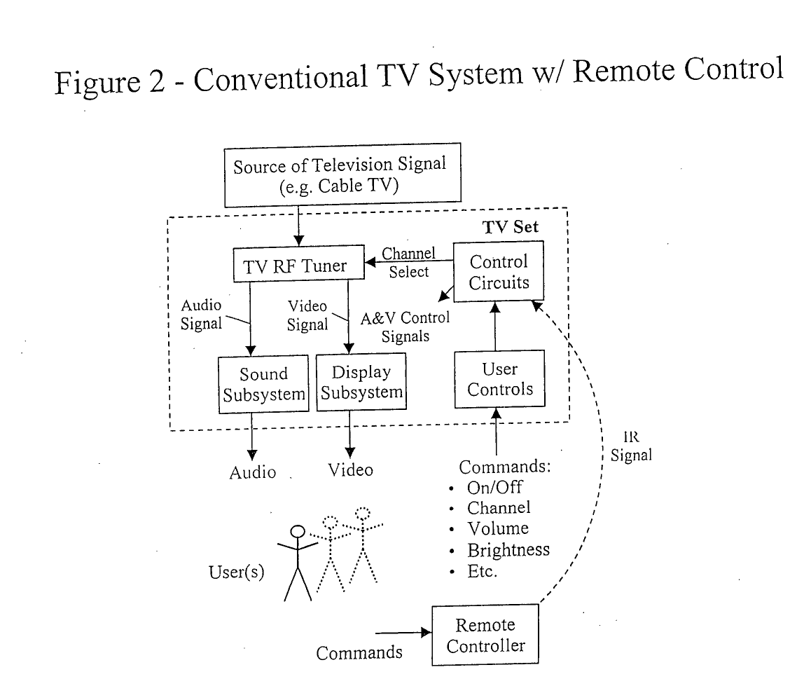

Typical television displays (and other video entertainment and computer displays) are directly tied (i.e. hardwired) to their source of information as exampled by the TV set shown in FIG. 1. FIG. 2 shows that the TV remote control solves part of the problem of separating the user interface from the information source, but the sound and the display (particularly the display) are still tied to the information source. The volume of information that must be sent on a continuing basis to satisfy the current users' expectations for real time video makes breaking the wires a challenging problem.

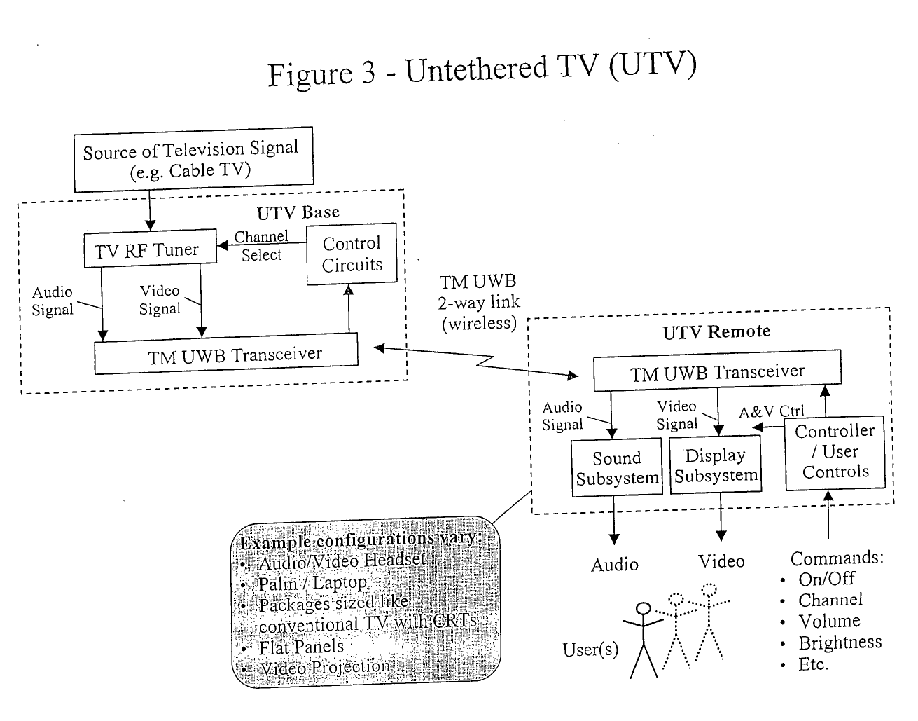

FIG. 3 shows the application of Time Modulated (TM ) Ultra-WideBand (UWB) transceivers in a configuration that breaks the conventional wire boundaries and allows a repackaging of the television from a single TV set to a Base unit and a Remote unit. Such an architectural separation allows the information sources and the conventional or new High Definition TV tuners and demodulators to be separately packaged from the audio/video remote.

A first TM UWB Transceiver (also known as Impulse Radio) is interfaced with the one or more audio/video information sources. The nature of the audio/video signal interfaces depends of the selected information source. These signals could be analog or digital in nature and represent: composite video, individual video colors such as RGB, mono or stereo sound, color computer monitor signals, existing video formats such as NTSC, MPEG, MJPEG, DVD, or baseband (RS170). The source of information may assume file formats such as .jpg or .mpg. Some information may be in compressed form. The interface to the TM UWB Transceiver is adapted to accept the variety of signal types needed for the intended application(s) and further conditions and/or compresses these signals as required to fit within the available transmission bandwidth of approximately 5 Mbps. This combined unit is referenced as the UTV Base. The operation of the TM UWB Transceivers in a duplex communication architecture and their data capacity are described in the above referenced patents.

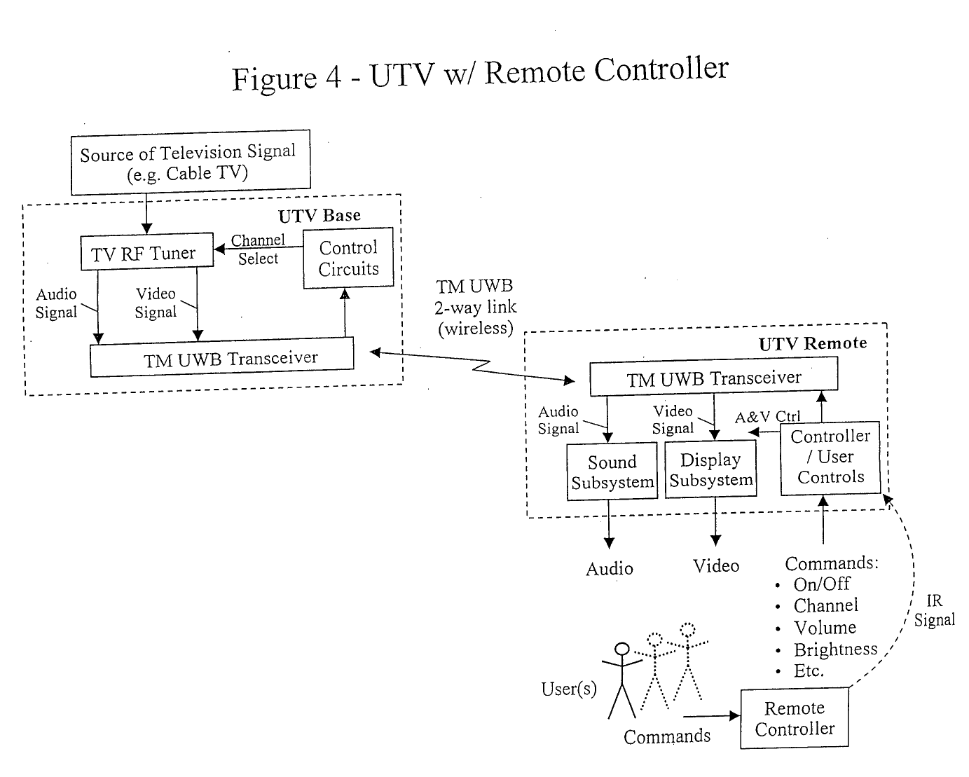

A second TM UWB Transceiver is packaged with a video display, sound system, and user controls. This transceiver receives the high bandwidth signal from the UTV Base, extracts the audio and/or video information, and provides that information to the corresponding audio or video subsystem. The audio subsystem consists of conventional audio amplifiers and speakers. The video subsystem consists of a conventional video display terminal or computer monitor employing a CRT and its associated driver circuits or the equivalent flat panel, LCD or plasma displays. This combined unit is referenced as the UTV Remote. The exact configuration of the UTV Remote would be quite varied. One unit intended to serve a single user might be quite small and highly portable for use in various parts of the home or patio, while another unit intended for group viewing might be large and essentially stationary. Palmtop or laptop computers might be adapted to serve as a UTV Remote. A cordless audio/video headset featuring 3D video and sound is an instance of a UTV remote. The smaller UTV Remotes take full advantage of the mobility and multipath handling afforded by UTV and the UWB radio link; the larger UTV Remote benefits from the elimination of cables and the ability to select from the variety of information sources. FIG. 4 shows the case of a larger, relatively stationary Remote UTV configuration, in which a conventional TV remote control unit is used in conjunction with the Remote UTV just as it is currently used with conventional TV.

The transceivers operate in a duplex communication mode that is highly asymmetric in that the majority of information flows from the information source (base unit) to the display (remote unit), and a much smaller amount of information flows from the user controls (remote unit) to the information source (base unit).

Process for Using UTV

1. User activates the UTV Remote.

2. A duplex communication link is established between the Remote and Base transceivers.

3. User interacts with the UTV Remote to select the desired information source and set controls as with regular TV. This information is sent from the Remote to the Base on the low data rate portion of the link.

4. The UTV Base accesses the specified information source and processes it for transmission as needed.

5. Depending on the format of the data at the information source, one or more data compression techniques may be applied to bring the required data rate down to the order of 5 Mbps (million bits per second).

6. The data containing the audio and/or video information is transmitted between from the Base to the Remote using TM UWB signals as needed to support real time presentation to the user.

7. The received data is decompressed as needed and used to drive the display and sound systems.

8. The reverse, lower data rate portion of the link is used to maintain the link quality and to carry additional user commands to the Base.

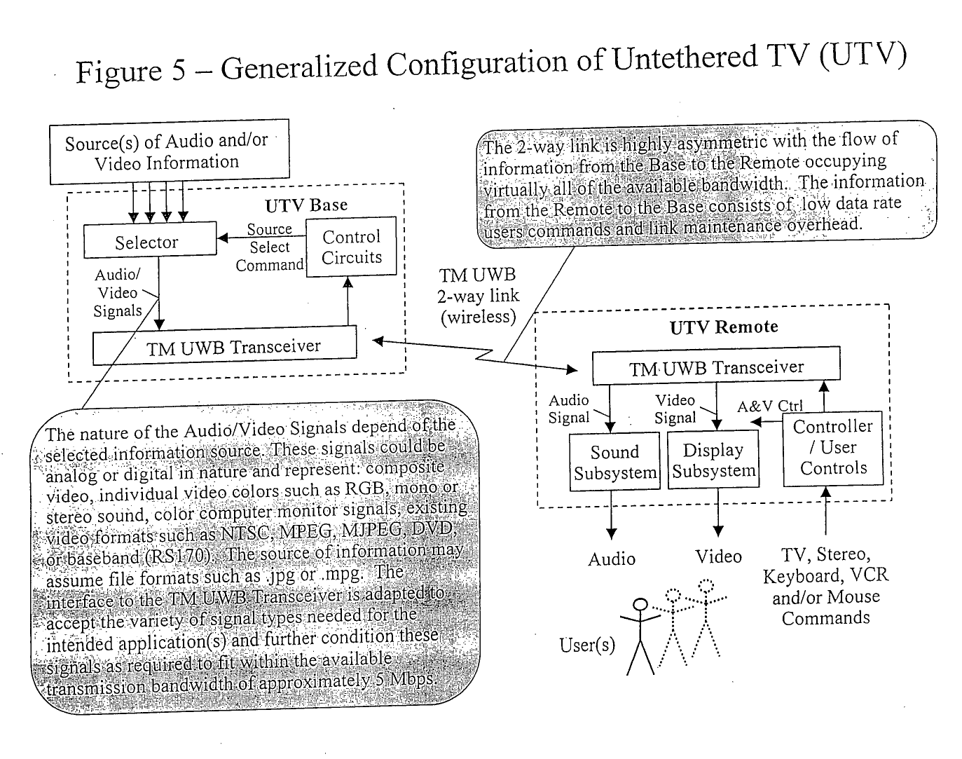

The foregoing discussion has emphasized the UTV application. FIG. 5 shows a more generalized configuration that recognizes that TV is but a single application of a wireless, high bandwidth audio/video user interface. While portable computers continue to decrease in size and increase in performance, the ability to split the user interface from the base computer, hard disk, and network interface functions opens an innovative approach to a “portable” computer. Such an approach does not necessarily make the computer portable, it only makes the user interface portable and leaves the bulk of the computer stationary elsewhere in the home. A UTV Remote configured as a general purpose audio/video user interface could be used for a variety of purposes including reading the downloaded newspaper, accessing a computer in a standalone or networked configuration, viewing a live TV broadcast (conventional or HDTV), viewing a stored or taped movie, listening to music, playing a video game, projecting a video signal, controlling a home security system, or answering the phone.

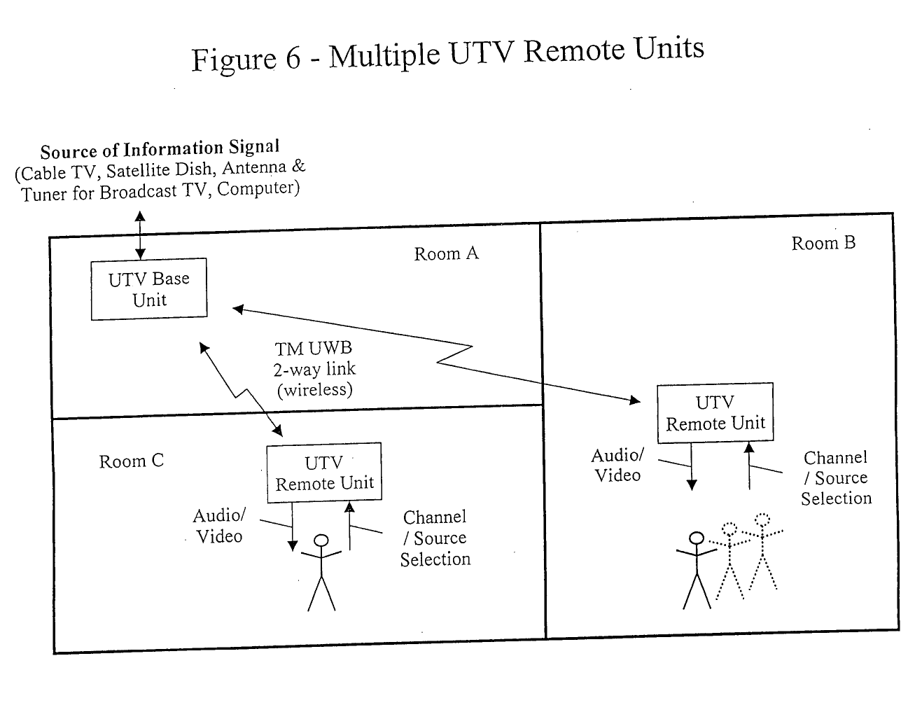

FIG. 6 depicts the use of multiple UTV Remotes in a home. Each of these remotes could serve the diverse applications as exampled above.

Multipath Advantage

Multipath in a container is severe. Rayleigh fading conditions prevail.

Decay times may be hundreds of nanoseconds. Reflections may be in the hundreds. Direct path may be obscured by other stacked assets, boxes, containers. Propagation conditions approach Rayleigh conditions. Severe Rayleigh nulls prevent good coverage. Transmit power must be increased to minimize the effect of nulls. Spread spectrum techniques or diversity receivers may be used to overcome these effects, but these approaches add complexity to the receiver.

Impulse radio offers advantages in a multipath environment. Impulse radio offers low cost spectrum spreading.

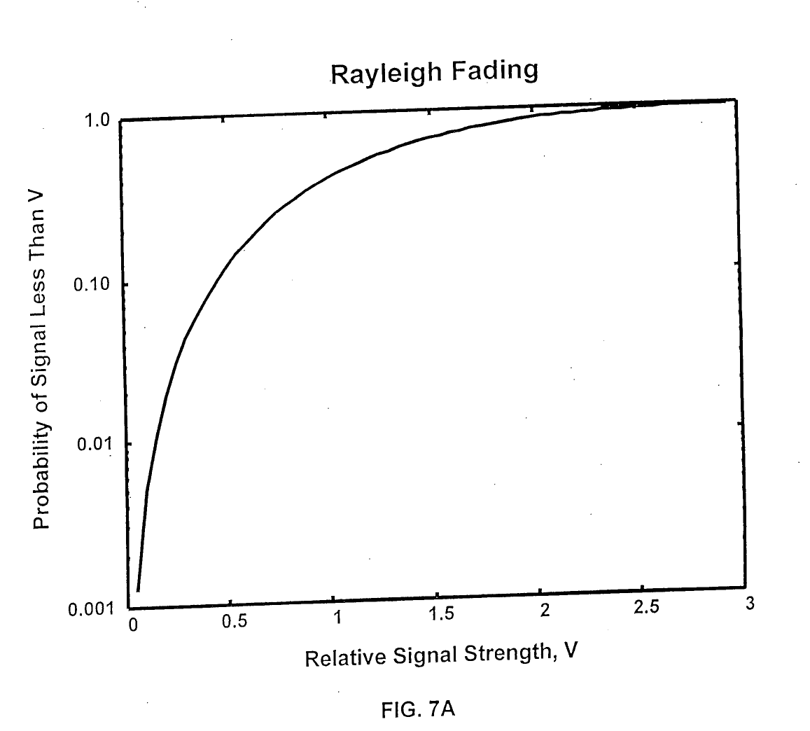

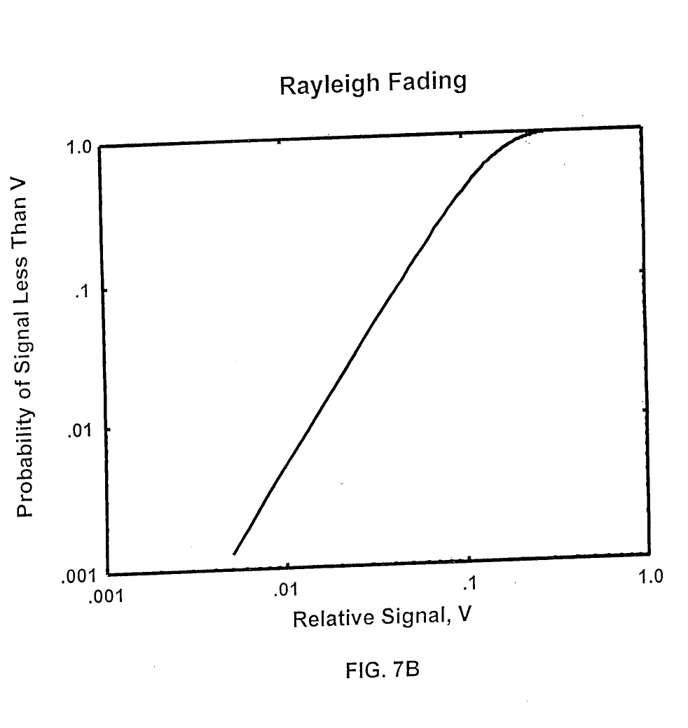

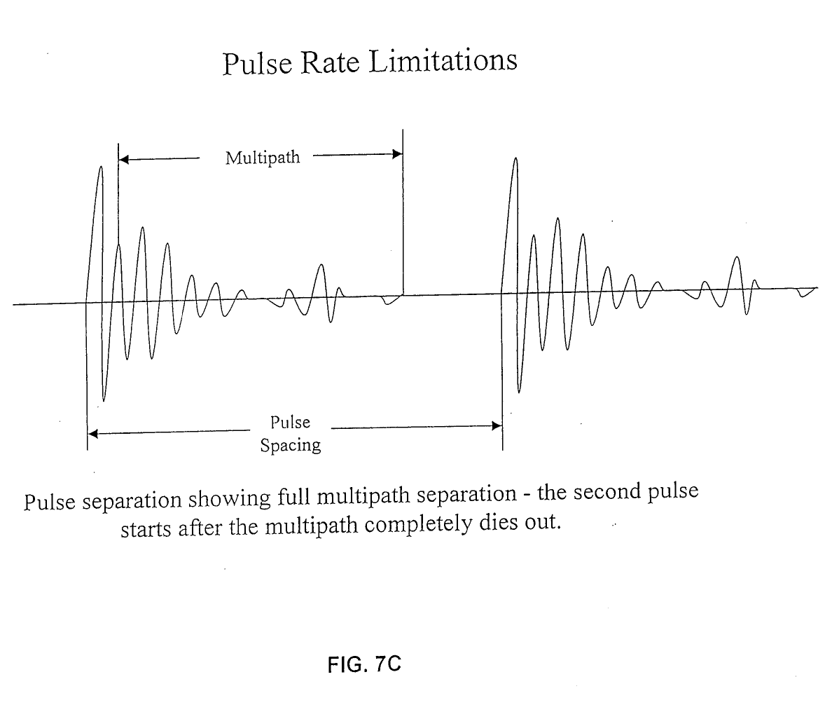

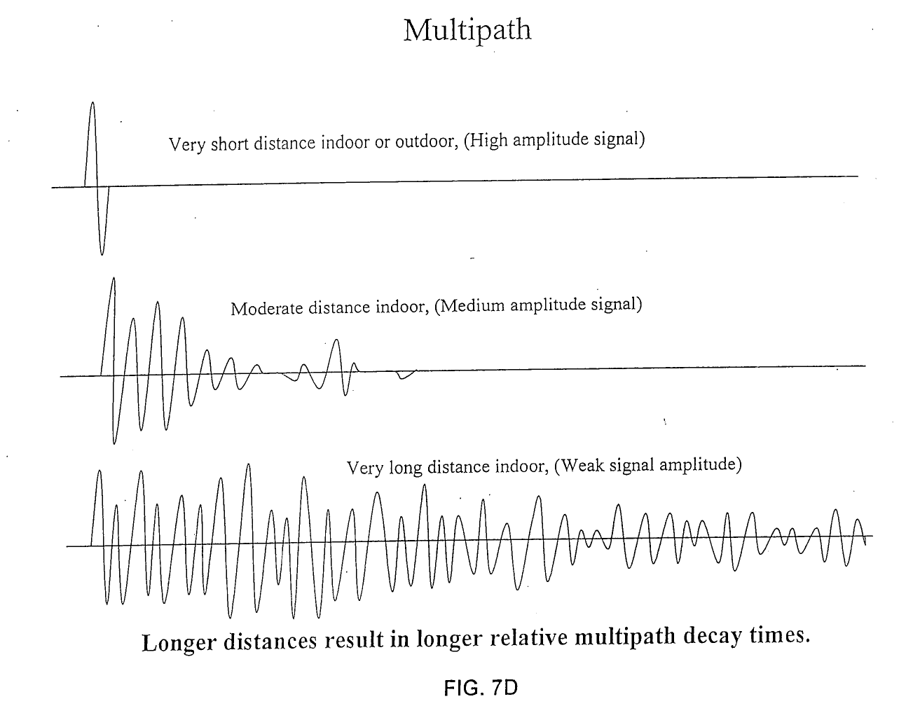

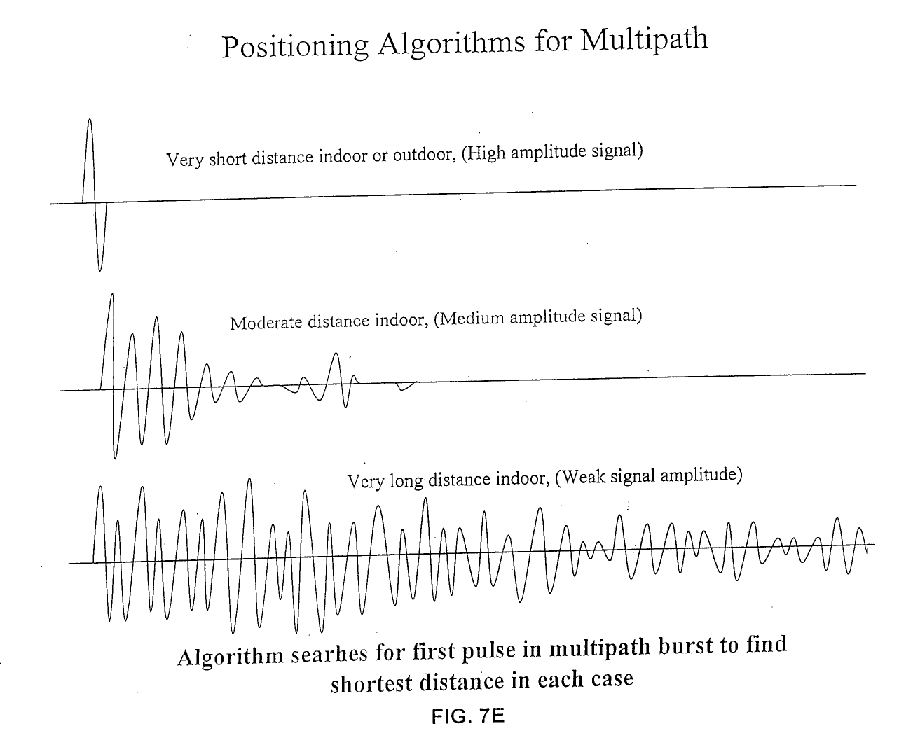

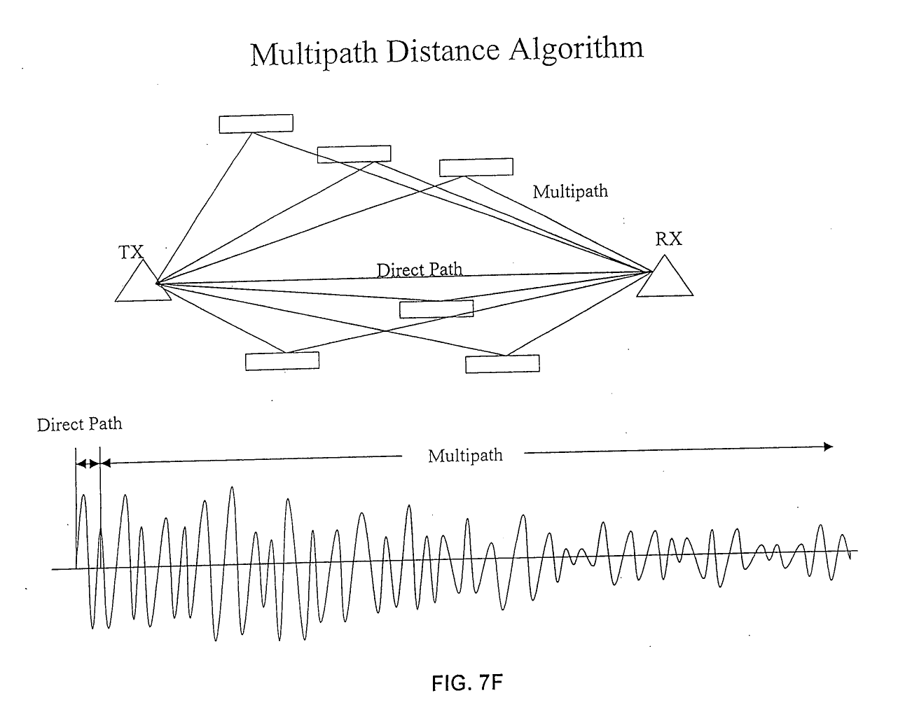

In the frequency domain, multipath reflections have an envelope that follows a Rayleigh distribution as in FIGS. 7A and 7B. It can be seen that a 90% coverage represents 16 dB attenuation. This suggests that 16 db additional power is needed to cover to 90%. Likewise 99% requires 26 dB excess power.

Using an impulse transmitter and synchronous receiver, such as a synchronously triggered scope, a map of the impulse response of a channel may be made as shown in FIGS. 7D-7F.

Multipath Distance Algorithm

Lock on the signal at any point. Multipath may be stronger than the direct path signal, thus the first lock on the strongest signal, or first found signal may not be the direct path.

Set the timer to an earlier time and test for signal. Return to the first lock point to maintain lock if necessary. Keep backing up until no signal is found.

Alternatively, one may back up a predetermined distance (10 ns) and then search forward slowly, using maximum integration gain to find any weak remnant of the direct path signal.

The backup and search is then repeated until no signal is found. This finds the earliest signal, which is the most direct path available.

In a rake receiver, with two or more correlators, or a receiver that can multiplex a correlator between at least two time delays, the receiver can stay locked to a given first lock point and search with arbitrary integration gain on any other time delay because there will be no drift due to oscillator instability. (In the case of mobile units, Doppler drift must still be considered.)

### CONCLUSION

The present invention can be implemented using the various impulse radio techniques disclosed in the above-referenced impulse radio patent documents, which are incorporated herein by reference. Additionally, other impulse radio techniques, such as subcarrier modulation disclosed in above-referenced U.S. Pat. No. 5,677,927 for example, can be used together with the present invention.

While specific embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

1. (canceled)

2. A system, comprising
a tuner adapted to receive a signal;
a video display physically separate from the tuner;
a first UWB transceiver;
a second UWB transceiver coupled to the video display and operable to receive a signal to therby drive the video display; and
a third UWB transceiver, coupled to the tuner, operable to determine the position of the second UWB transceiver based on the first UWB transceiver and the second UWB transceiver, and transmit the signal to the second transceiver based on the position of the second UWB transceiver.

3. The system of claim 2, wherein the third UWB transceiver is operable to transmit the signal as a time-modulated ultra-wideband impulse signal.

4. The system of claim 2, wherein the third UWB transceiver is further operable to transmit the signal to the second UWB transceiver based on an identity of the second UWB transceiver.

5. The system of claim 4, wherein the third UWB transceiver determines the identity of the second UWB transceiver using a key.

6. The system of claim 2, wherein the signal is compressed by the third UWB transceiver and decompressed by the second UWB transceiver.

7. A method, comprising
receiving a signal at a tuner;
determining the position of a first UWB transceiver based on a second UWB transceiver and a third UWB transceiver;
transmitting the signal to the first UWB transceiver based on the position of the first UWB transceiver;
receiving the signal at the first UWB receiver; and
driving a video display physically separate from the tuner using the signal.

8. The method of claim 7, wherein the signal is transmitted as a time-modulated ultra-wideband impulse signal.

9. The method of claim 7, wherein the signal is transmitted to the first UWB transceiver based on an identity of the first UWB transceiver.

10. The method of claim 9, further comprising determining the identity of the first UWB transceiver using a key.

11. The method of claim 7, further comprising compressing the signal and decompressing the signal.
